(19) United States
(12) Patent Application Publication
(10) Pub. No.: US 2003/0030895 A1
(43) Pub. Date: Feb. 13, 2003

(54) Optical amplifiers and optical amplifying method for improved noise figure

(76) Inventors: Vincent So, Ottawa (CA); Zhenguo Lu, Orleans (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 10/025,867

(22) Filed: Dec. 26, 2001

Related U.S. Application Data
(60) Provisional application No. 60/300,826, filed on Jun. 27, 2001.

(51) Int. Cl. H01S 3/00

(52) U.S. Cl. 359/349

(57) ABSTRACT

Provided are optical amplifiers and method for amplifying an optical signal with an improved noise figure. This is achieved by exploiting the coherence (data) and incoherence of an optical. More specifically, an optical signal is split into two path signals that propagate and are amplified along two independent paths. The path signals each carry a signal path component and an external noise path component. After amplification the path signal each further carry an ASE (amplified spontaneous emission) path component wherein the ASE path components are un-correlated. While the ASE components are combined, at a combination point, such that the ASE power is substantially divided between a main output and one or more subsidiary outputs, an optical path length difference between the two paths is properly tuned such that the signal path components are combined constructively at the main output and experience maximal output and such that at least a portion of external noise power is diverted to the one or more subsidiary outputs.

### RELATED APPLICATIONS

This application claims the benefit of U.S. Provisional Patent Application Serial No. 60/300826 filed Jun. 27, 2001.

### FIELD OF THE INVENTION

This invention relates generally to optical communications systems. More specifically, the invention relates to optical amplifiers for large-capacity wavelength-division-multiplexed (WDM), optical communication systems.

### BACKGROUND OF THE INVENTION

In optical systems the signal-to-noise ratio (SNR) of an optical signal tends to degrade as it propagates through optical media such as optical wave-guides or optical fibers. The SNR of the optical signal may also degrade when the optical signal propagates through optical devices such as multiplexers. Opto-electronic regenerators can be used to improve the SNR of the optical signal but these devices are costly and inefficient. Erbium-doped fiber amplifiers (EDFAs) have been used to amplify weak optical signals without opto-electronic conversion. However, the amplification process adds noise causing SNR degradation. Noise performance in optical amplifiers is typically measured by the noise figure (NF) which is defined as the ratio of the SNR at the input of the optical amplifier to that at the output of the optical amplifier (NF=SNRᵢₙ/SNRₒᵤₜ). Under ideal conditions, a fiber amplifier may be fully inverted and the theoretical lower limit on the NF is 3 dB. This corresponds to the quantum limit of the NF. This quantum limit of the NF has limited the effectiveness of fiber amplifiers. Some optical amplifiers [R. A. Griffin, P. M. Lane, and J. J. O'Reilly, “Optical amplifier noise figure reduction for optical single-sideband signals,” Journal of Lightwave Technology, Vol.17, No.10, 1999, pp.1793-1796.] are used for NF reduction of optical single-sideband signals only and are not suited for other data-format signals and multi-channel optical signals. Other optical amplifiers [S. Lee, “Low-noise fiber-optic amplifier utilizing polarization adjustment,” U.S. Pat. No. 5,790,721, Aug. 4, 1998] [S. Lacroix, F. Gonthier, and J. Bures; “Modeling of symmetric 2×2 fused-fiber couplers,” Applied Optics, Vol.33, No.36, 1994, pp.8361-8369.] [D. J. DiGivanni, J. D. Evankow, J. A. Nagel, R. G. Smart, J. W. Sulhoff, J. L. Zyskind, “High power, high gain, low noise, two-stage optical amplifier,” U.S. Pat. No. 5,430,572, Jul. 4, 1995.] have been developed to lower the NF but they are constrained by the 3 dB quantum limit. Some optical amplifiers [Z. Lu and V. So, “Very low noise figure optical amplifier devices”, U.S. patent application Ser. No. 09/819,748, 2001] [z.y. Ou. S. F. Pereira, 2 and H. J. Kimble, “quantum Noise Reduction in Optical Amplification,” Physical Review Letters, Vol. 70, No. 21, 1993, pp. 3232-3242] are, in some cases, not constrained by the 3 dB quantum limit but, in other cases, such amplifiers are limited either by a long coherence length of an amplified spontaneous emission (ASE) generated during amplification or by a squeezed vacuum in an amplifier's internal mode.

### SUMMARY OF THE INVENTION

Provided is an optical amplifier that amplifies an optical signal while improving signal-to-noise ratio (SNR). This is achieved by exploiting coherence (data) and incoherence of an optical signal. More specifically, an optical signal is split into two path signals that propagate and are amplified along two independent paths. The path signals each carry a signal path component that carries data and a noise path component that carries a remaining portion of the optical signal consisting of an external noise path component. After amplification, the noise path components each carry an additional ASE (amplified spontaneous emission) path component wherein the ASE path components are un-correlated and incoherent. While the ASE path components are combined, at a combination point, such that ASE power is substantially divided between a main output and one or more subsidiary outputs, an optical path length difference between the two paths is properly tuned such that the signal path components are combined constructively at the main output and experience maximal output and such that at least a portion of the power of the external noise path components is diverted to the one or more subsidiary outputs.

In accordance with one broad aspect of the invention, the invention provides a method of amplifying an optical signal. The method includes splitting the optical signal into two path signals each having a signal component and a noise path component. The path signals are then amplified through independent amplification stages such that, after amplification, each path signal carries an additional respective ASE path component wherein the ASE path components are substantially incoherent. A respective phase adjustment is then performed on at least one of the path signals before or after amplification such that the signal path components of the path signals can be combined constructively at a combination point. At the combination point, the path signals are then combined to produce an output optical signal.

In amplifying the path signals, the ASE path components may be substantially incoherent. This might result in ASE power of the respective ASE path components being substantially divided between a main output and a subsidiary output. The respective phase adjustment(s) might further be performed in a manner such that, at the combination point, the external noise path components may be at least partially incoherent. This might result in the power of the noise path components being diverted to a subsidiary output. In addition, a phase adjustment might be applied to both path signals. The phase adjustments may include a linear phase adjustment and may also include a non-linear phase adjustment. The non-linear phase adjustment may be due to non-linear effects such as, for example, self-phase modulation effects. These self-phase modulation effects may occur in optical gain media through which the path signals propagate as they are amplified. Furthermore, the non-linear phase adjustment may be controlled by controlling the self-phase modulation effects through the gain during amplification. The linear phase adjustment may be applied by passing the path signals through respective OTM (optical transmission media) having different optical path lengths. An optical path length difference, ΔLₒ, between the OTM may be chosen to satisfy a symbol shift tolerance. As such, the optical path length difference might substantially satisfy ΔL_{O}≦χC/ω wherein C is the speed of light, ω is a carrier data rate of the input optical signal and χ is the symbol shift tolerance.

The linear phase adjustments might also be chosen such that the optical path length difference, ΔLₒ, between the two path signals, is less than a maximum optical path length difference, ΔLₘₐₓ, the path signals can tolerate while satisfying the symbol shift tolerance. Furthermore, the external noise path components may have a coherence length, L_{c}, and if the coherence length, L_{c}, is less than ΔLₘₐₓ, then the optical path length difference may be chosen to satisfy L_{c}<ΔLₒ≦ΔLₘₐₓ, otherwise the optical path length difference might simply be chosen to satisfies ΔLₒ≦ΔLₘₐₓ.

The respective phase adjustment(s) may result in the signal path components of the path signals being substantially in phase with each other to an integral multiple of 2π. The method may also be applied to an optical signal having a plurality of equally spaced channels wherein any two consecutive channels with frequencies f′ and f of the equally spaced channels may differ by Δf=f′−f. Furthermore, the optical path length difference, ΔLₒ, between the two path signals, might substantially satisfy ΔL=KC/(2Δf), wherein K=1, 2, 3, . . . and C is the speed of light in vacuum.

Another broad aspect of the invention provides an optical amplifier arrangement. The optical amplifier arrangement includes an optical splitter, two OTM, a gain block within each one of the OTM and an optical coupler. The optical splitter is adapted to split an optical signal into two path signals, each having a signal path component and a noise path component, that propagate through a respective one of the OTM, are amplified by a respective one of the gain blocks and recombined through the optical coupler. The optical amplifier arrangement also has a phase controller in at least one of the optical transmission media. In some embodiments, the optical amplifier arrangement may have a phase controller in each optical transmission media. The phase controllers are adapted to apply a phase adjustment to a respective one of the two path signals such that substantially all of the power of the signal path components is produced at a main output and wherein a portion of the power of the noise path components is diverted to a subsidiary output.

An ASE power arising from amplification in the gain blocks might be substantially divided between the main output and one or more subsidiary outputs irrespective of the phase adjustment made to the respective one of the two path signals. In addition, the phase controller might be further adapted to apply the phase adjustment in a manner that, at the combination point, external noise path components of the noise path components are at least partially incoherent. This might result in at least a portion of external noise power being diverted to one or more subsidiary output(s).

In some embodiments, at least one of the gain blocks might be an EDFA (erbium-doped fiber amplifier) or an SOA (Semiconductor Optical Amplifier).

The optical amplifier arrangement, in combination with one or more optical amplifier(s), may form a multistage optical amplifier. In such embodiments of the invention, the optical amplifier arrangement might be a first stage of the multistage optical amplifier. In other embodiments, the optical amplifier arrangement might be used as a pre-amplifier and in yet other embodiments the pre-amplifier might precede an optical receiver to form a receiver structure.

In some embodiments, the optical amplifier might include an additional phase controller. In other embodiments, the optical splitter, the two OTM, and the output optical coupler together may comprise a Mach-Zehnder interferometer.

The optical amplifier arrangement may be applied to an optical signal having a plurality of equally spaced channels. Any two consecutive channels of the equally spaced channels may have frequencies f′ and f that differ by Δf=f′−f. In addition, the optical path length difference, ΔLₒ, between the two path signals, might substantially satisfy ΔLₒ=KC/(2Δf), wherein K=1, 2, 3, . . . and C is the speed of light in vacuum.

The optical amplifier arrangement might further include processing and sensing circuitry that may be adapted to control the phase adjustment and/or gain in the gain blocks. The optical splitter might be a 1×2 3-dB single-mode fused-fiber coupler or a 2×2 3-dB single-mode fused-fiber coupler. In the latter case, one of two inputs of the 2×2 3-dB single-mode fused-fiber coupler might be terminated locally. The optical coupler might also be a 2×2 3-dB single-mode fused-fiber coupler and the OTM might be wave-guides or optical fibers.

In some embodiments, the optical amplifier arrangement might have at least one additional optical transmission medium which might be connected to the optical splitter and to the optical coupler for a total of M OTM. In such embodiments, each one of the at least one additional optical transmission medium might have a gain block and/or a phase controller.

### BRIEF DESCRIPTION OF THE DRAWINGS

Preferred embodiments of the invention will now be described with reference to the attached drawings in which:

FIG. 1 is a schematic block diagram of a conventional optical amplifier;

FIG. 2 is a schematic block diagram of an optical amplifier, provided by an embodiment of the invention;

FIG. 3 is a schematic block diagram of an optical amplifier, provided by a second embodiment of the invention;

FIG. 4 is a schematic block diagram illustrating an optical amplifier that includes the optical amplifier of FIG. 2 and a control mechanism for tuning the performance of the optical amplifier;

FIG. 5 is a schematic block diagram illustrating a two-stage optical amplifier, provided by another embodiment of the invention;

FIG. 6 is a schematic block diagram illustrating a two-stage optical amplifier that includes the two-stage optical amplifier of FIG. 5 and a control mechanism for tuning the performance of the two-stage optical amplifier;

FIG. 7 is a flow chart of a method of amplifying an optical signal; and

FIG. 8 is a flow chart of a method of designing a phase difference for use in the optical amplifiers of FIGS. 2 to 6.

### DETAILED DESCRIPTION OF THE PREFERRED EMBODIMENTS

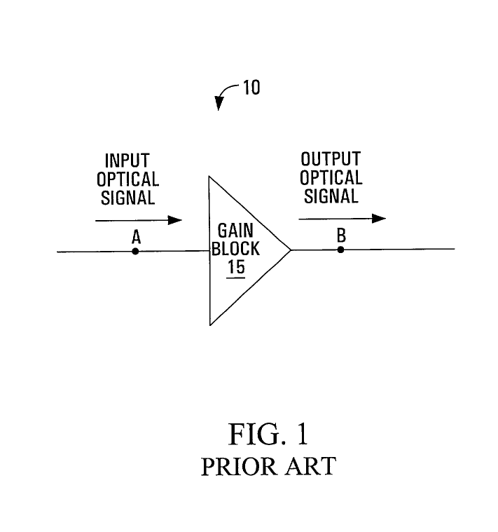

Referring to FIG. 1, shown is a schematic block diagram of a conventional optical amplifier 10. The conventional optical amplifier 10 comprises a gain block 15.

An input optical signal is input at a point A that corresponds to an input of the conventional optical amplifier 10. The input optical signal has a signal component of power, Pᵢₙ(A) at point A and a noise component of power Pₙₒᵢₛₑ(A) at point A. The signal component carries data being transmitted and the noise component carries a remaining non-data portion of the input optical signal. The signal component typically has a longer coherence length than the noise component. The input optical signal is amplified through the gain block 15 and undergoes a gain G resulting in an output optical signal that is output at a point B that corresponds to an output of the conventional optical amplifier 10. The output optical signal has a signal component carrying data and a noise component carrying a remaining portion of the output optical signal with powers Pₒᵤₜ(B) GPᵢₙ(A) and Pₙₒᵢₛₑ(B) P_{ASE}+GPₙₒᵢₛₑ(A) at point B, respectively. P_{ASE} corresponds to the power of a forward component of an amplified spontaneous emission (ASE) generated in the gain block 15.

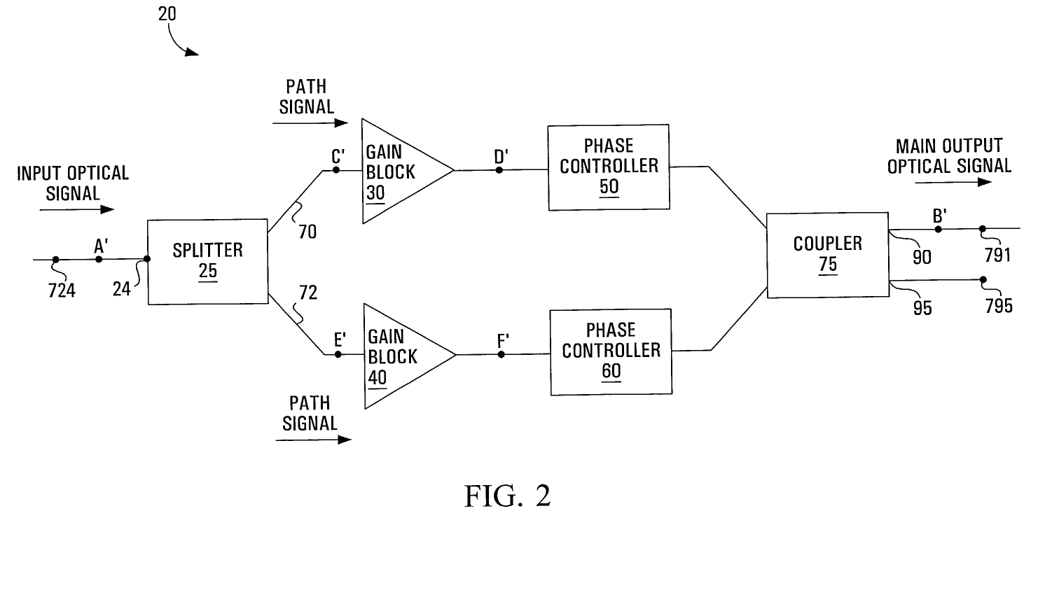

Referring to FIG. 2, shown is a schematic block diagram of an optical amplifier generally indicated by 20, provided by an embodiment of the invention. A point A′ corresponds to an input 724 of the optical amplifier 20 and an input 24 of an input optical splitter 25. The input optical splitter 25 is connected through to an output optical coupler 75 through two parallel paths comprised of optical transmission media (OTM) 70, 72, respectively. The OTM 70, 72 are any suitable OTM such as optical fibers or wave-guides. The output optical coupler 75 has a main output 90 at a point B′ that corresponds to a main output 791 of the optical amplifier 20. The output optical coupler 75 also has a subsidiary output 95 that is terminated locally at a subsidiary output 795 of the optical amplifier 20. Within each one of the parallel paths is a respective one of two gain blocks 30,40 and a respective one of two phase controllers 50,60. The two gain blocks 30,40 any suitable gain blocks, for example erbium-doped fiber amplifiers or semiconductor optical amplifiers, capable of amplifying optical signals.

The optical amplifier 20 is used to amplify an input optical signal, having a signal component and a noise component. The optical amplifier has an improved noise figure when compared to conventional optical amplifiers. By way of overview, amplification is achieved by first splitting the input optical signal into two path signals; independently amplifying the path signals; performing a phase adjustment of the path signals; and then recombining the paths signals such that substantially all of signal power associated with data being transmitted is recombined at the main output 90 and such that noise power associated with a remaining portion of the path signal is divided between the main output 90 and the subsidiary output 95.

The input optical signal has a signal component and a noise component with powers P′ᵢₙ(A′) and P′ₙₒᵢₛₑ(A′) at point A′, respectively, for a total power P′(A′)=P′ᵢₙ(A′)+P′ₙₒᵢₛₑ(A′). The signal component carries data being transmitted. The noise component carries a portion of the input optical signal other than a portion carrying the data being transmitted such as, for example, noise and/or ASE. The noise component may also include external noise and/or ASE generated within other optical components within a network of which the optical amplifier 20 forms a part. The input optical splitter 25 splits the input optical signal into two path signals that propagate through a respective one of the OTM 70, 72 to a respective one of the gain blocks 30,40. Preferably, the input optical splitter 25 performs a 50/50 split of the input optical signal such that at points C′ and E′ the path signals have signal path components and noise path components with powers P′ᵢₙ(C′)=P′ᵢₙ(E′)=P′ᵢₙ(A′)/2 and P′ₙₒᵢₛₑ(C=P′ₙₒᵢₛₑ(E′)=P′ₙₒᵢₛₑ(A′)/2, respectively. The path signals are amplified through a respective one of the gain blocks 30,40 and each one of the path signals preferably undergoes a gain G′. At a point D′, the signal path component and the noise path component of one of the path signals have powers P′ₒᵤₜ(D′)=G′P′ᵢₙ(C′)=G′P′ᵢₙ(A′)/2 and P′ₙₒᵢₛₑ(D′)=P′_{ASE}+G′P′ₙₒᵢₛₑ(C′)=P′_{ASE}+G′P′ₙₒᵢₛₑ(A′)/2, respectively, where P′_{ASE} corresponds to the power of a forward component of an ASE, referred to as an ASE path A. component, generated in gain block 30. Similarly, at a point F′, the signal path component and the noise path component of the other path signal have powers P′ₒᵤₜ(F′)=G′P′ᵢₙ(E′)=G′P′ᵢₙ(A′)/2 and P′ₙₒᵢₛₑ(F)=P′_{ASE}+G′P′ₙₒᵢₛₑ(E)=P′_{ASE}+G′P′ₙₒᵢₛₑ(A′)/2, respectively. After being amplified the noise path components therefore each carry an additional ASE path component with power P′_{ASE} and an external noise path component with power G′P′ₙₒᵢₛₑ(C′)=G′P′ₙₒᵢₛₑ(E′). Embodiments are not limited to each one of the path signals undergoing the same gain G′. In some embodiments of the invention, one of the path signals undergoes a gain G′ and another one of the path signals undergoes a gain G″. In such an embodiment, an ASE power, P′_{ASE}, is generated in one of the gain blocks 30,40 and an ASE power, P″_{ASE}, is generated in another one of the gain blocks 30,40.

The two path signals thus amplified propagate through a respective one of the phase controllers 50,60. The phase controllers 50,60 perform fine phase adjustments to the two path signals, for example by adjusting an optical path length of a respective one of the two OTM 70, 72. Phase adjustments are made in a manner such that, at the output optical coupler 75, the signal path components are recombined constructively at the main output 90. The manner by which the phase adjustments are performed and the path signals are recombined is described in detail below. At the output optical coupler 75 the ASE path components are recombined such that the ASE power, P′_{ASE}, generated in the gain blocks 30,40 is substantially divided between the main output 90 and the subsidiary output 95. In addition, external noise path components of the noise path components are at least partially divided and preferably evenly divided between the main output 90 and the subsidiary output 95. Consequently, resulting at the main output 90 is an output optical signal that propagates to point B′ where it is output. The output optical signal has a signal component and a noise component with powers P′ₒᵤₜ(B′) and P′ₙₒᵢₛₑ(B′) at point B′, respectively. For identical input optical signals the output optical signal has an enhanced SNR compared to the SNR of the output optical signal of FIG. 1. As such, the optical amplifier 20 has an improved noise when compared to the noise figure of the convention optical amplifier 10. The enhanced SNR is due to the following two effects that are discussed in further details below: 1) Independently amplifying the paths signal results in the ASE power of the ASE path components being substantially divided between the main and subsidiary outputs, 90,95, respectively, irrespective of the phase difference between the path signals; 2) A phase adjustment of a phase difference between the path signals results in the external noise path component of the noise path components to be at least partially incoherent. As a result external noise power of the external noise path components is at least partially divided between the main output 90 and the subsidiary output 95 thereby diverting a portion of the power of the external noise path components.

Theory of the Invention

The theory of the invention will be described in a manner which shows how the performance of the optical amplifiers 10, 20 of FIGS. 1 and 2 differ. As discussed above, the noise components of the input optical signals of FIGS. 1 and 2 have respective powers Pₙₒᵢₛₑ(A) and P′ₙₒᵢₛₑ(A′) at points A and A′, respectively. More particularly, Pₙₒᵢₛₑ(A) and P′ₙₒᵢₛₑ(A′) correspond to power of a respective one of the noise components of the input optical signals of FIGS. 1 and 2 each measured over a bandwidth B₀. Pₙₒᵢₛₑ(A) and P′ₙₒᵢₛₑ(A′) is due to external optical sources such as, for example, transmitters and optical fiber amplifiers connected within a network that includes a respective one of the conventional optical amplifier 10 and the optical amplifier 20. The optical SNR of the input optical signal at point A of FIG. 1 is:

$$S N {R}_{i n} ( A ) = \frac{{P}_{i n} ( A )}{{P}_{n o i s e} ( A )} . \qquad ( 1 )$$

Once the input optical signal has been amplified through the gain block 15 and undergone a gain G, an optical SNR of the resulting output optical signal at point B is given by

$$S N {R}_{o u t} ( B ) = \frac{{P}_{o u t} ( B )}{{P}_{n o i s e} ( B )} = \frac{G {P}_{i n} ( A )}{{P}_{A S E} + G {P}_{n o i s e} ( A )} \qquad ( 2 )$$

where P_{ASE} is also measured over the bandwidth B₀.

As an illustrative example, it is assumed that the gain blocks 15, 30, 40 are identical and are working under the same pumping conditions. In addition, the power of the input optical signal in FIG. 1 is the same as the power of the input optical signal of FIG. 2 (i.e. Pᵢₙ(A)=P′ₘ(A′) and Pₙₒᵢₛₑ(A)=P′ₙₒᵢₛₑ(A′)). The power of the signal and noise path components of the path signals at points C′ and E′ is therefore given by

$$\begin{matrix}{P}_{i n}^{′} ( {C}^{′} ) = {P}_{i n}^{′} ( {E}^{′} ) = \frac{{P}_{i n}^{′} ( {A}^{′} )}{2} = \frac{{P}_{i n} ( A )}{2} & ( 3 ) \\ {P}_{n o i s e}^{′} ( {C}^{′} ) = {P}_{n o i s e}^{′} ( {E}^{′} ) = \frac{{P}_{n o i s e}^{′} ( {A}^{′} )}{2} = \frac{{P}_{n o i s e} ( A )}{2} . & ( 4 )\end{matrix}$$

The optical SNR of the path signals at points C′ and E′ are therefore given by

$$S N {R }_{i n} ( {C}^{′} ) = S N {R }_{i n} ( {E}^{′} ) = \frac{{P}_{i n} ( {C}^{′} )}{{P}_{n o i s e} ( {C}^{′} )} = \frac{{P}_{i n} ( {E}^{′} )}{{P}_{n o i s e} ( {E}^{′} )} = \frac{{P}_{i n} ( A )}{{P}_{n o i s e} ( A )} = S N {R}_{i n} ( A ) \qquad ( 5 )$$

After undergoing a gain of G′ through a respective one of the gain blocks 30,40, the optical SNR of the path signals at points D′ and F′ are given by

$$\begin{matrix}S N {R}_{o u t} ( {D}^{′} ) = \frac{{P}_{o u t}^{′} ( {D}^{′} )}{{P}_{n o i s e}^{′} ( {D}^{′} )} = \frac{{G}^{′} {P}_{i n}^{′} ( {C}^{′} )}{{P}_{A S E}^{′} + {G}^{′} {P}_{n o i s e}^{′} ( {C}^{′} )} = \frac{{G}^{′} {P}_{i n} ( A )}{2 {P}_{A S E}^{′} + {G}^{′} {P}_{n o i s e} ( A )} & ( 6 ) \\ S N {R}_{o u t} ( {F}^{′} ) = \frac{{P}_{o u t}^{′} ( {F}^{′} )}{{P}_{n o i s e}^{′} ( {F}^{′} )} = \frac{{G}^{′} {P}_{i n}^{′} ( {E}^{′} )}{{P}_{A S E}^{′} + {G}^{′} {P}_{n o i s e}^{′} ( {E}^{′} )} = \frac{{G}^{′} {P}_{i n} ( A )}{2 {P}_{A S E}^{′} + {G}^{′} {P}_{n o i s e} ( A )} & ( 7 )\end{matrix}$$

The phase controllers 50,60 perform phase adjustments such that the signal path components are recombined constructively at the main output 90. Consequently the power of the output optical signal at point B′ is given by

$${P}_{o u t}^{′} ( {B}^{′} ) = \frac{{P}_{o u t}^{′} ( {D}^{′} )}{2} + \frac{{P}_{o u t}^{′} ( {F}^{′} )}{2} + 2 \sqrt{\frac{{P}_{o u t}^{′} ( {D}^{′} )}{2} \frac{{P}_{o u t}^{′} ( {F}^{′} )}{2}} = {G}^{′} {P}_{i n} ( A ) \qquad ( 8 )$$

Equation (8) is satisfied, and consequently constructive interference occurs, when the signal path components differ by an overall phase difference, δ, with δ=±2pπ with p=0, 1, 2, . . . . As discussed above, the noise path components each comprise an ASE path component and an external noise path component with the ASE path components being un-correlated and incoherent and the external noise path components being at least partially incoherent. Therefore, the noise path components are recombined by the output optical coupler 75 such that the ASE path component power, P′_{ASE}, is substantially divided between the main output 90 and the subsidiary output 95 while external noise power of the external path components is at least partially diverted to the subsidiary output 95. As such, the power of the noise component of the output optical signal at point B′ is given by

$${P}_{n o i s e}^{′} ( {B}^{′} ) = {P}_{A S E}^{′} + {G}^{′} \frac{{P}_{n o i s e} ( A )}{2} ( 1 + m ) \qquad ( 9 )$$

where m is a measure of coherence of the external path components at the recombination point. The measure m satisfies 0≦m≦1 wherein at a limit m=0 the external path components are completely incoherent and at a limit m=1 the external noise path components are completely incoherent. An intermediate case corresponds to a case when the external noise path components are partially coherent. From equations (8) and (9) the optical SNR of the output optical signal at point B′ is given by

$$S N {R}_{o u t} ( {B}^{′} ) = \frac{{P}_{o u t}^{′} ( {B}^{′} )}{{P}_{n o i s e}^{′} ( {B}^{′} )} = \frac{2 {G}^{′} {P}_{i n} ( A )}{2 {P}_{A S E}^{′} + {G}^{′} {P}_{n o i s e} ( A ) ( 1 + m )} \qquad ( 10 )$$

A comparison between the SNR of the input optical signal and the output optical signal is described by the ratio SNRₒᵤₜ(B′)/SNRᵢₙ(A′) where SNRᵢₙ(A′) is the SNR of the input optical at point A′. A condition for an increase in SNR in amplifying the input optical signal is that SNRₒᵤₜ(B′)/SNRᵢₙ(A′)>1. The ratio SNRₒᵤₜ(B′)/SNRᵢₙ(A′) is given by

$$\frac{S N {R}_{o u t} ( {B}^{′} )}{S N {R}_{i n} ( {A}^{′} )} = \frac{{P}_{o u t}^{′} ( {B}^{′} )}{{P}_{n o i s e}^{′} ( {B}^{′} )} \frac{{P}_{n o i s e}^{′} ( {A}^{′} )}{{P}_{i n}^{′} ( {A}^{′} )} = {( \frac{{P}_{A S E}^{′}}{{G}^{′} {P}_{n o i s e}^{′} ( {A}^{′} )} + \frac{( 1 + m )}{2} )}^{- 1} . \qquad ( 11 )$$

Consequently, the condition that the SNR is increased during amplification requires that

P′_{ASE}<G′P′ₙₒᵢₛₑ(A′)(1−m)/2 (12)

When m<1 and P′ₙₒᵢₛₑ(A′) is large, SNRₒᵤₜ(B′)>SNRᵢₙ(A′) resulting in an improvement in signal-to-noise ratio.

Discussed below is a proof showing that for identical optical signals input at a respective one of the conventional optical amplifier 10 and the optical amplifier 20, the SNR of the output optical signal of optical amplifier 20 is always greater than the SNR of the output optical signal of the conventional optical amplifier 10, irrespective of the gain and ASE power in either one of the conventional optical amplifier and the optical amplifier 20. This proves that the new design has an improved noise figure. The proof begins by assuming that the optical SNR of the output optical signal of the optical amplifier 20 is greater than the optical SNR of the output optical signal of the conventional optical amplifier 10 and then showing that an inequality resulting from this assumption holds true irrespective of gain and associated ASE power within a respective one of the conventional optical amplifier 10 and the optical amplifier 20. The inequality is given by

SNRₒᵤₜ(B′)>SNRₒᵤₜ(B) (13)

and can be re-written as

$$\frac{2 {G}^{′} {P}_{i n}^{′} ( {A}^{′} )}{2 {P}_{A S E}^{′} + {G}^{′} {P}_{n o i s e}^{′} ( {A}^{′} ) ( 1 + m )} > \frac{G {P}_{i n} ( A )}{{P}_{A S E} + G {P}_{n o i s e} ( A )} \qquad ( 14 )$$

Since the input optical signals for both the conventional optical amplifier 10 and the optical amplifier 20 are identical then P′ᵢₙ(A′)=Pᵢₙ(A) and P′ₙₒᵢₛₑ(A′)=Pₙₒᵢₛₑ(A), and equation (14) is re-written as

2G′P_{ASE}+GG′Pₙₒᵢₛₑ(A)(1−m)>2GP′_{ASE} (15)

Based on optical methods, the relationship between the ASE power P_{ASE} or P′_{ASE}, and the gain G or G′, respectively, can be expressed as

P_{ASE}=hνB₀G·10^{0.1NF} (16)

P′_{ASE}hνB₀G′·10^{01NF′} (17)

where P′_{ASE} and P_{ASE} correspond to ASE power, measured over the bandwidth B₀ (in Hz), of a gain block with input signal power Pᵢₙ(A)/2 and Pᵢₙ(A), respectively; NF′ and NF are noise figures of respective ones of the gain blocks 30,40 and 15 with signal path component power P′ᵢₙ(C′)=P′ᵢₙ(E′)=Pᵢₙ(A)/2 and Pᵢₙ(A), respectively; h is Planck's constant; ν is the optical frequency (Hz) of the input optical signals; G′ and G are given in linear units with the signal path component power P′ᵢₙ(C′)=P′ᵢₙ(E′)=Pᵢₙ(A)/2 and Pᵢₙ(A) respectively.

From equations (15), (16) and (17) obtained is

2hνB₀·10^{0.1NF}+Pₙₒᵢₛₑ(A)(1−m)>2hνB₀·10^{0.1NF′} (18)

When the input power of an optical fiber amplifier is small enough such that an optical fiber amplifier is working in a small-signal gain region the noise figure either increases or remains constant with increasing input power. When the input power is large enough so that an optical amplifier is working in the saturated gain region, the noise figure always increases with increasing input power. Consequently, since the power of the signal component of the input optical signal that is input at the conventional optical amplifier 10 is always greater than the power of the signal path components that are input at a respective one of the gain blocks 30,40 (Pᵢₙ(A)>P′ᵢₙ(C′)=P′ᵢₙ(E′)=Pᵢₙ(A)/2) then NF>NF′. In addition, the term Pₙₒᵢₛₑ(A) (1−m) in equation (18) is always greater or equal to zero. Consequently equation (18), or equivalently equation (13), is verified for any cases with respect to optical fiber amplifiers 10,20. Clearly, there are improvements to the SNR of an optical signal amplified by the optical amplifier 20 of FIG. 2 when compared to the SNR of an optical signal amplified by the optical amplifier 10 of FIG. 1. The result is an improved noise figure of the optical amplifier 20 when compared to the conventional optical amplifier 10.

The individual components of FIG. 2 will now be described in further detail.

Input Optical Coupler

The function of the input optical splitter 25 is to split the input optical signal with total power, P′(A′)=P′ᵢₙ(A′)+P′ₙₒᵢₛₑ(A′), at its input 24 into two path signals having preferably the same total power, P′(A′)/2. A phase difference, Δφ₀, may be introduced. In a preferred embodiment of the invention, the input optical splitter 25 is a 1×2 3-dB single-mode fused-fiber coupler. In another embodiment of the invention, the input optical splitter 25 may be a 2×2 3-dB single-mode fused-fiber coupler. In embodiments of the invention in which the input optical splitter 25 is a 2×2 3-dB single-mode fused-fiber coupler, the input optical signal is input at one of two inputs of the 2×2 3-dB single-mode fused-fiber coupler and another one of the two inputs of the 2×2 3-dB single-mode fused-fiber coupler is terminated locally. In other embodiments of the invention, the input optical splitter is a micro-optical coupler or any type of optical device capable of producing the required function.

Optical Transmission Media

In the preferred embodiment of FIG. 2, the OTM 70, 72 are optical fibers. In another embodiment of FIG. 2, the OTM 70, 72 are wave-guides. An optical signal that propagates through one of the OTM 70, 72 undergoes a phase shift, φ₁(\vec{r}). Similarly, another optical signal that propagates through another one of the OTM 70, 72 undergoes a phase shift, φ₂(\vec{r}). The phase controllers 50 and 60 are used to fine tune the phase shifts φ₁(\vec{r}), φ₂(\vec{r}) respectively.

A phase difference, Δφ(\vec{r})=φ₁(\vec{r})−φ₂(\vec{r}) is introduced partially by the OTM 70, 72 per se and partially by the phase shifts introduced by the phase controllers 50,60. The component introduced by the OTM 70, 72 per se may be due to different physical lengths of the OTM 70, 72 and/or different indexes of refraction of the OTM 70, 72. An overall phase difference at the combination point (the output optical coupler 75) can be expressed as δ=Δφ(\vec{r})+Δφ₀, a coarse phase adjustment of the phase difference, δ, can be achieved by first choosing different respective physical lengths of the OTM 70, 72 and/or by using lengths of OTM having different respective nominal indexes of refraction. Fine adjustment of the phase difference δ is performed using the phase controllers 50,60.

Gain Blocks

Each one of the gain blocks 30,40 is used to amplify a respective one of the path signals preferably with a gain G′. Embodiments of the invention are not limited to embodiments in which the path signals are amplified with equal gains. The gain blocks 30,40 are any suitable gain blocks such as EDFAs. Such gain blocks may comprise a pump light source such as a pump laser source or any other suitable pump light source.

Phase Controllers

The phase controllers 50,60 may be any devices capable of introducing in a controllable manner the required fine phase shift into the overall phase difference experienced by path signals propagating in the OTM 70, 72. In the preferred embodiment of FIG. 2, each one of the phase controllers 50, 60 is connected between a respective one of the gain blocks 30, 40 and the optical coupler 75. In other embodiments of the invention, each one of the phase controllers 50, 60 is connected between the optical splitter 25 and a respective one of the gain blocks 30, 40. In one embodiment of the invention, the phase controllers 50 and 60 are heaters and the fine phase adjustment is done by changing the indexes of refraction of at least portions of the OTM 70, 72 by heating one or both of the OTM 70, 72.

In some embodiments, a linear phase shift and a non-linear phase shift are introduced as part of the fine phase adjustments. The linear phase shift is introduced by having the path signals within the phase controllers 50, 60 propagate through OTM of different optical path lengths. The non-linear phase shift is introduced by non-linear effects in active gain media of the gain blocks 30, 40 through which the path signals propagate. For example, in one embodiment, the non-linear effects are due to self-modulation effects the active gain media caused by carrier depletion. The self-modulation effects are sensitive to the gain G′ and therefore the non-linear phase shift is adjusted with only a small change in the gain.

In some embodiments, the phase controllers 50,60 are adapted to apply a stretching force to at least portions of one or both of the OTM 70, 72. This can be achieved for example through the use of piezo-electric devices. Any other suitable phase controllers capable of varying the optical path lengths of the OTM 70, 72 may be used.

In the embodiment of FIG. 2, the fine phase shift is implemented through a combination of the two phase controllers 50 and 60. In another embodiment, the fine phase shift is implemented through the use of only a single phase controller, for example phase controller 50 in which case phase controller 60 is not required. However, it is noted that the use of both phase controllers 50 and 60 allows the phase difference to be finely adjusted with more ease and accuracy.

In a preferred embodiment of the invention each one of the OTM 70, 72 has a constant index of refraction throughout its length. Nominally, an optical path length difference, ΔLₒ, given by ΔLₒ=n₁L₁−n₂L₂ where L₁ and L₂ are the physical lengths of respective ones of the OTM 70, 72 and n₁ and n₂ are the indexes of refraction of respective ones of the OTM 70, 72. In another embodiment of the invention the indexes of refraction of the OTM 70, 72 vary over the length of their respective medium. Consequently, ΔLₒ=∫n₁(s₁)ds₁−∫n₂(s₂)ds₂. For example, each path may have a number of segments each having a length and each having an index of refraction in which case

$$Δ {L}_{o} = {{\sum }_{i = 1}}^{{N}_{1}} {}_{i}^{}{n}{}_{1 i}^{} {L}_{1} - {{\sum }_{i = 2}}^{{N}_{2}} {}_{i}^{}{n}{}_{2 i}^{} {L}_{2}$$

where one of the OTM 70, 72 is composed of N₁ segments with the i^{th} segment having indexes of refraction and lengths {ᵢn₁,ᵢL₁}. Similarly, the another one of the OTM 70, 72 is composed of N₂ segments with the i^{th} segment having indexes of refraction and lengths {ᵢn₂,ᵢL₂}. In this case, the fine phase control can be achieved through appropriate adjustment of any one or more of the indexes of refraction ᵢn₁,ᵢn₂ and lengths ᵢL₁,ᵢL₂. Furthermore, the indexes of refraction may vary continuously from one segment to another and/or within a segment in which case the integral representation of ΔLₒ is a more accurate representation.

Output Optical Coupler

The output optical coupler 75 is used as a combination point for combining two path signals having a phase difference, δ, at its two inputs. As indicated previously, the power of the signal path component of the output optical signal at the main output 90 of the output optical coupler 75 is P′ₒᵤₜ(B′)=G′P′ᵢₙ(A′) when the signal path components of the path signals are combined constructively. The condition for constructive interference requires that the two signal path components at the inputs of the output optical coupler 75 have a constant overall phase difference, δ=±2pπ where p=0, ±1, ±2, . . . . When this condition is satisfied, the two signal path components are coupled entirely into the main output 90 of the output optical coupler 75 with power, P′ₒᵤₜ(B′)=G′P′ᵢₙ(A′), with no power of the signal path components being output at the subsidiary output 95. Any deviations from 2pπ will result in some of the power of the signal path components being output at subsidiary output 95 and lost. On the other hand, two optical signals that propagate through optical paths having an optical path length difference which is greater than their coherence length have an effective phase difference, δ, which is a random function of time. Such optical signals cannot interfere constructively and are said to be incoherent. In such a case the two optical signals are coupled equally into the main output 90 and the subsidiary output 95. In the case when the phase difference between the optical signals is small resulting in the optical signals being partially incoherent less than 50% of the power of the optical signals is coupled into the subsidiary output 95.

In the preferred embodiment of FIG. 2, the output optical coupler 75 is a 2×2 3-dB single-mode fused-fiber coupler with a 50:50 coupling ratio. More generally, any coupling device capable of combining signal path components, and splitting off noise path components to subsidiary outputs may be employed.

Design Constraints

The signal and noise path components of the path signals that propagate through the OTM 70, 72 end up with an overall phase difference of δ=Δφ(\vec{r})+Δφ₀. The selection of this phase difference is made to ensure that the external noise path components of the noise path components are at least partially incoherent, and preferably completely incoherent at the point where recombination is to take place and to ensure that the signal path components combine constructively. The phase difference can be expressed as an optical path length difference, ΔLₒ, and the selection of the phase difference results in constraints on ΔLₒ.

A) Symbol Shift Tolerance

When the signal components are split and then recombined, one of the signal path components is delayed with respect to the other. This results in a slight spreading of the symbols being carried by the recombined signal component. The symbol rate applies another condition that limits the optical path length difference to ΔLₒ≦χC/R, where C is the speed of light in vacuum; R is the symbol rate of the optical signals and χ is a fraction indicating a maximum symbol shift to which the system is tolerant. For example, χ=0.2 indicates a 20% tolerance. This requirement is put in place to avoid the effects of smearing/dispersion which would result should the signal path components be so different in phase that a substantial symbol shift occurs.

B) Coherence Length

The optical path length difference, ΔLₒ, is preferably selected to be greater than the coherence length, L_{c}, of the external noise path components of the noise path components of the path signals (ΔLₒ>L_{c}). The choice ΔLₒ>L_{c} assures that the noise path components of the two path signals are independent and thus have a random phase difference between them and ensures that any noise path components are split approximately evenly between the main and subsidiary outputs 90,95, respectively, of the output optical coupler 75. When L_{c}≧χC/R both conditions ΔLₒ>L_{c} and ΔLₒ≦χC/R cannot be satisfied simultaneously. In such a case the condition ΔLₒ>L_{c} is not imposed but ΔLₒ is preferably chosen to be as large as possible within the limits imposed by the symbol shift tolerance. If ΔLₒ is less than L_{c}, then it is possible that some fraction less than 50% of the external noise path components of the noise path components will be directed to the subsidiary output. This reduces the SNR improvement, but still yields a workable design.

C) Constructive Combination

The optical path length difference, ΔLₒ, expressed as a phase difference in δ=Δφ(\vec{r})+Δφ₀. This quantity is selected such that the phase difference satisfies δ=2pπ where p=0, ±1, ±2, . . . , for the wavelength(s) of interest with the result that the signal path components are coupled into the main output 90 and combined constructively. While there are many phase differences that satisfy 2pπ, p=±1, ±2, . . . , some of these are preferably eliminated for failing to satisfy the coherence length constraint. Typically, the coherence length constraint requires the phase difference to satisfy 2pπ, where p is an integer with |p|>Pₘᵢₙ where Pₘᵢₙ is a function of the coherence length.

D) Multi-channel Applications

As discussed above, the power of the output optical signal is tuned (or equivalently, SNR′ₒᵤₜ(B′) is tuned) by performing a fine phase adjustment using the phase controllers 50,60. In tuning the power of the output optical signal the phase difference, δ, preferably satisfies δ=2pπ where p=0, ±1, ±2, . . . ,. For multi-channel applications, a method is applied to an optical signal having a plurality of equally spaced channels wherein any two consecutive channels with input wavelengths λ′ and λ of the equally spaced channels differing by a spectral difference, Δλ=λ′−λ. The method requires that the optical path length difference, ΔLₒ, satisfies ΔLₒKλλ′/2n(Δλ), where K=1, 2, 3, . . . , and where n is the index of refraction of an optical transmission medium at an input point. Equivalently, this condition is satisfied by two consecutive channels of frequency f′ and f simultaneously when ΔL₀=KC/(2Δf), where K=1, 2, 3, . . . , C is the speed of light in vacuum and Δf=f′−f. Therefore, the optical amplifier 20 separates a number of periodically spaced channels of the input optical signal at the optical splitter 25 and outputs the respective channels at the main output 90 with each channel having an increase in SNR. For example, a channel space of 100 GHz around λ=1550-nm with an optical path length difference of 1 mm, 2 mm, 3 mm, 4 mm or 5 mm is practical and satisfies OC192 networking systems. If the optical path length difference, ΔLₒ, is too long OC192 networking systems requirements are not satisfied. The optical path length difference, ΔLₒ, may also be chosen to be approximately equal to 1 mm or less to satisfy requirements of future OC768 networking systems. It is noted that the optical path length difference is preferably limited by ΔLₒ>L_{c} where L_{c} is the coherence length of the external noise path components of the noise path components. Since the ASE path components are uncorrelated, the limit on the optical path length difference depends only on the coherence length of the external noise path components, and not on the coherence length of the ASE path components. Consequently, the applicability of the optical amplifier 20 is not limited by the coherence length of the ASE generated during amplification.

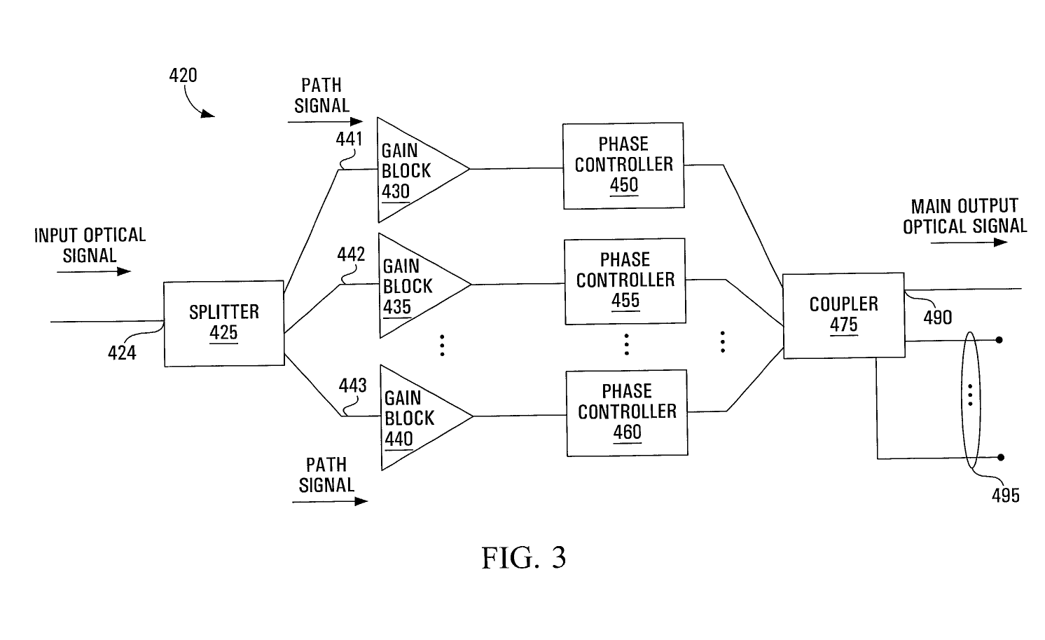

Referring to FIG. 3, shown is a schematic block diagram of an optical amplifier 420 provided by a second embodiment of the invention. The optical amplifier 420 has an input that corresponds to an input 424 of an input optical splitter 425. In the preferred embodiment of FIG. 3, the input optical splitter 425 is a 1×M optical coupler and has one input that corresponds to input 424 and it has M outputs (only three shown). In another embodiment of FIG. 3, the input optical splitter 425 is an M×M coupler and it has M inputs and M outputs. In such an embodiment, M−1 of the M inputs are terminated locally. There are M optical transmission media (only three shown), three of which are optical transmission media 441, 442 and 443. Each one of the M optical transmission media is connected between one of the M outputs of the input optical splitter 425 and one of M inputs (only three shown) of an output optical coupler 475. The optical lengths of the M optical transmission media are preferably chosen such that the optical path length difference, ΔLₒ, between any two of the M optical transmission media is greater than the coherence length, L_{c}, of external noise path components of noise path components of M path signals propagating through the respective M optical transmission media. Each one of the M optical transmission media passes through a gain block (only three shown). For example, the optical transmission media 441, 442 and 443 pass through gain blocks 430, 435 and 440, respectively. Similarly, each one of the M optical transmission media passes through a phase controller (only three shown). For example, the optical transmission media 441, 442 and 443 pass through phase controllers 450, 455 and 460, respectively. The output optical coupler 475 is a M×M coupler that has M outputs (only three shown) one of which is a main output 490 that corresponds to an output of the optical amplifier 420. The remaining M−1 outputs (only two shown), shown collectively at 495, are subsidiary outputs that are terminated locally.

In the preferred embodiment of FIG. 3, each one of the M optical transmission media passes through a respective one of the M phase controllers. In another embodiment of FIG. 3, there are M−1 phase controllers and all but one of the M optical transmission media passes through a respective one of the M−1 phase controllers. Preferably, there is at least one phase controller.

In the preferred embodiment of FIG. 3, an input optical signal is input at input 424. The input optical signal has a signal component and a noise component with powers, Pᵢₙ and Pₙₒᵢₛₑ, respectively. The input optical splitter 425 splits the input optical signal into M path signals. Each one of the M path signals has a signal and a noise path component. The signal path components of the path signals have the same power, Pᵢₙ/M, but vary in phase with a phase difference, φᵢ₀−φⱼ₀ where i,j=1,2, . . . , M, between any two path signals of the M paths. Similarly, the noise path components of the two path signals have the same power, Pₙₒᵢₛₑ/M. The signal and noise path components of each of the M path signals propagate through a respective one of the M optical transmission media and undergo a phase shift, φᵢ(\vec{r}) (i=1 to M). For example, the signal and noise path components of three path signals propagate through a respective one of the optical transmission media 441, 442 and 443 and undergo phase shifts, φ₁(\vec{r}), φ₂(\vec{r}) and φ₃(\vec{r}), respectively. Each one of the M path signals is amplified by a respective one of the M gain blocks. For example, each one of three path signals propagates through a respective one of the optical transmission media 441, 442, 443 is amplified by a respective one of the gain blocks 430, 435, 440 and undergoes a gain G. The M phase controllers perform a fine phase adjustment of the phase shift φᵢ(\vec{r}) (i=1 to M) such that an overall phase difference, δ=φᵢ(\vec{r})+φᵢ₀−φⱼ₀ (i, j=1 to M). between any two of the signal path components of the M path signals satisfies δ=2pπ where p=0, ±1, ±2, . . . . After propagating through a respective one of the M phase controllers the respective path signal then propagates to a respective input of the M inputs of the output optical coupler 475. At the output optical coupler 475 the signal path components of the M path signals are combined constructively such that the power of a signal component of an output optical signal at the main output 490 is approximately equal to GPᵢₙ. In addition, at the output optical coupler 475 the noise path components of the M path signals are coupled approximately equally into the M outputs such that the power of a noise component of the output optical signal at the main output 490 is approximately equal to P_{ASE}+GPₙₒᵢₛₑ/M in a limit when the noise path components are completely incoherent. More particularly, the noise component of the output optical signal has an ASE component with power P_{ASE} and an external noise path component with power GPₙₒᵢₛₑ/M.

Except for minor losses in the input optical splitter 425, the output optical coupler 475, the M optical transmission media and the M phase controllers, the power of the signal component of the output optical signal is approximately G times the power of the signal component of the input optical signal. The SNR of the output optical signal is therefore given by GPᵢₙ/(P_{ASE}+GPₙₒᵢₛₑ/M) in the limit that the noise path components are completely incoherent at the output optical coupler 475. This SNR is greater than the SNR of the optical signal of FIG. 2, which is given by equation (10). More particularly, since the external noise power is preferably evenly divided between the M outputs of the output optical coupler 475, the power of the external noise path component of the noise component of the output optical signal is decreased by a factor of approximately M.

Referring back to FIG. 2, in order to achieve the best possible SNR performance using the optical amplifier 20, preferably a control circuit is provided which enables the optical amplifier 20 to be tuned. More specifically, any phase controllers in the optical amplifier 20 may be adjusted so as to ensure a maximum amount of the signal component of the output optical signal is output at the main output 90, while at the same time diverting the power of the noise path components to subsidiary output 95 of the optical amplifier 20. Similarly, any gain block in the optical amplifier 20 may be adjusted so as to ensure a constant gain G′ and to control the non-linear phase shifts.

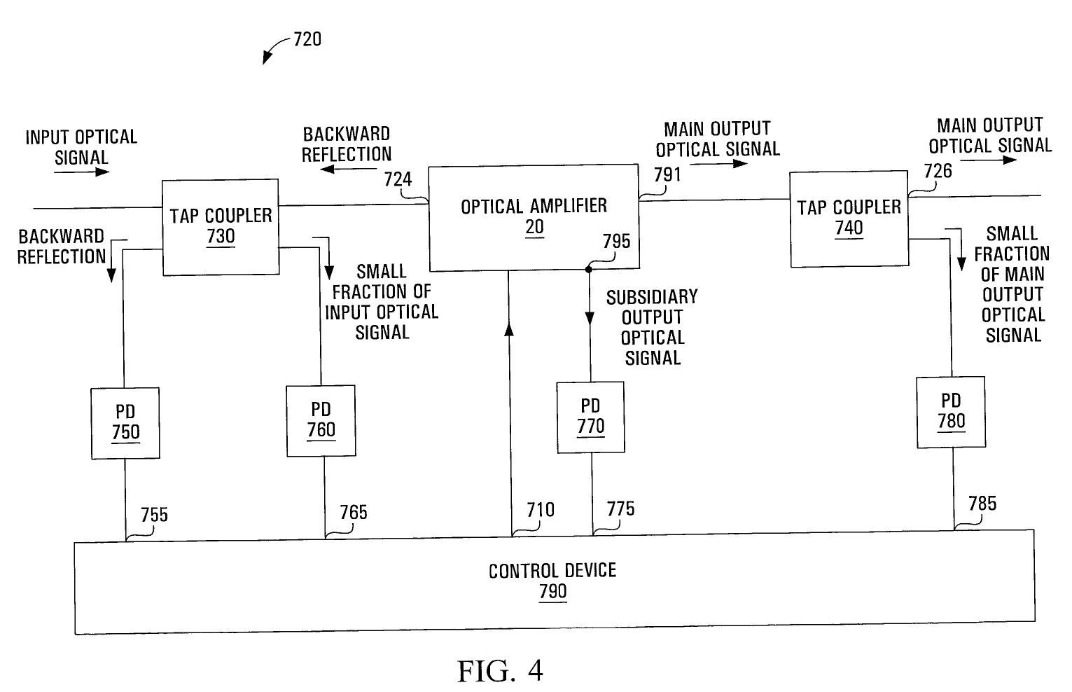

Referring to FIG. 4, shown is a schematic block diagram illustrating an optical amplifier 720 that includes the optical amplifier 20 of FIG. 2 and a control mechanism for tuning the performance of the optical amplifier 20. An input tap coupler 730 is connected to input 724 of the optical amplifier 20 and an output tap coupler 740 is also connected to the main output 791 of the optical amplifier 20. Two power hi detectors (PDs) 750,760 are connected to the input tap coupler 730. The PDs 750,760 are also connected to a control device 790 at a respective one of two inputs 755,765. A PD 770 is connected the subsidiary output 795 of the optical amplifier 20. The PD 770 is also connected to an input 775 of the control device 790. The control device 790 also has an output 710 that is connected to the optical amplifier 20. A PD 780 is connected to the output tap coupler 740. The PD 780 is also connected an input 785 of the control device 790. The control device 790 in one embodiment is a microprocessor, but more generally may be any device suitably designed and/or configured to perform analysis of signals output by the power detectors 750, 760, 770, 780 and to provide instructions for controlling gain and phase of path signals within the optical amplifier 20.

An input optical signal propagates to the input tap coupler 730. The input tap coupler 730 performs an asymmetric split of the input optical signal such that a significant fraction of the input optical signal propagates to optical amplifier 20 and a small fraction of the input optical signal propagates to the PD 760. The input tap coupler 730 might have a splitting ratio of 95.5% for example. The significant fraction of the input optical signal propagates to the optical amplifier 20 where it is amplified resulting in a main output optical signal with a signal component and an noise component, which is output at the main output 791. A subsidiary output optical signal is also output at the subsidiary output 795. At the optical amplifier 20, an ASE is generated, a component of which is all or part of the noise component power of the main and subsidiary optical signals and a component of which, referred to as backward reflection, propagates in a backward direction to the input tap coupler 730. The input tap coupler 730 performs an asymmetric split of the backward reflection such that a fraction of the backward reflection propagates to the PD 750 which may provide information about the backward reflection power from the optical amplifier 20. The backward reflection power from the optical amplifier 20 may, in turn, be of use in an optical networking system of which the optical amplifier 720 would typically form a part. The main output optical signal output by the optical amplifier 20 at the main output 791 propagates to the output tap coupler 740. The output tap coupler 740 performs an asymmetric split of the main output optical signal such that a significant fraction of the main output optical signal propagates out through a main output 726 that corresponds to an output of the optical amplifier 720. In addition, a small fraction of the output optical signal propagates out to the PD 780. The splitting ratio may be 99.1% for example.

The control device 790 provides instructions to the optical amplifier 20 for performing phase adjustments. The phase adjustments are described herein above with respect to the description of FIGS. 2 and 3. The control device 790 provides instructions to the optical amplifier 20 such that the power of the main output optical signal is maximised while the power of the subsidiary output optical signal is minimised. Preferably, the control device 790 also provides instructions to gain blocks within the optical amplifier 20 to control gain within the optical amplifier 20. The gain might be adjusted such that the performance of the optical amplifier satisfies any specified requirements, for example those of an optical networking system of which the optical amplifier 720 forms a part.

The PDs 750, 760, 770, 780 convert optical signals into electrical signals. The PD 750 converts the small fraction of the backward reflection from the optical amplifier 20 into an electrical signal that is sent to the control device 790 providing information on the backward reflection power. The PD 760 converts the small fraction of the input optical signal into an electrical signal that is sent to the control device 790 providing information on the power of input optical signal. The PD 770 converts the subsidiary output optical signal into an electrical signal that is sent to the control device 790 providing information on the power of the subsidiary output optical signal. The PD 780 converts the small fraction of the main output optical signal into an electrical signal that is sent to the control device 790 providing information on the intensity of the main output optical signal.

Typically, PDs 750,760 and 780 would be made use of by the optical networking system. PD 770 is used for the purpose of the optical amplifier 20 to get the right optical path length difference and the right gain. For example, the optical path length difference may be tuned until the power detected by the PD 770 is a minimum. In that state, assuming the requirement that the noise path components are incoherent has been satisfied, all of the power of the signal path components will be output at the main output 791, with only power of the noise path components being output at the subsidiary output 795. Any suitable control model may be used to hone in on a suitable optical path length difference on the basis of the output of PD 770.

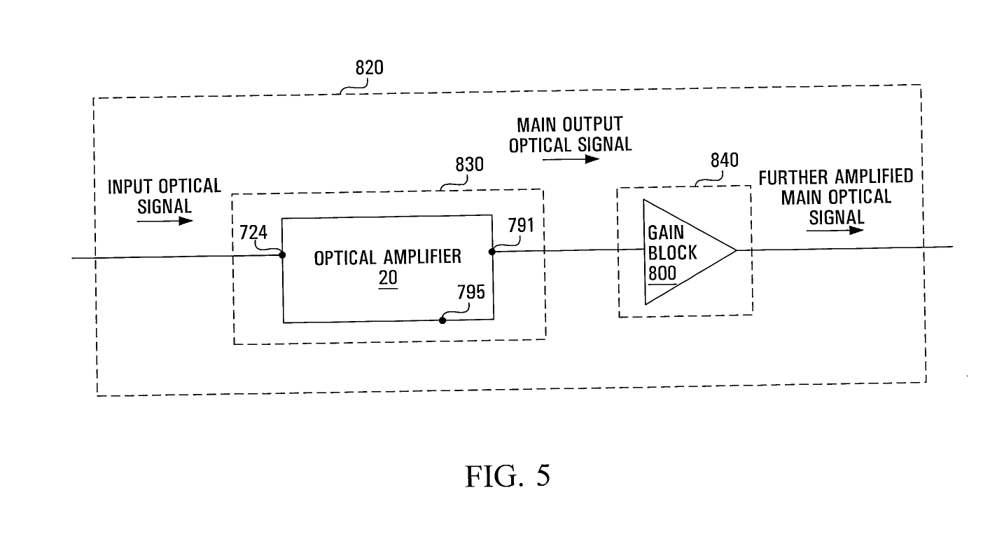

Referring to FIG. 5, shown is a schematic block diagram illustrating a two-stage optical amplifier 820 provided by another embodiment of the invention. The two-stage optical amplifier 820 includes a first stage optical amplifier 830 which corresponds to the optical amplifier 20 of FIG. 2. The By two-stage optical amplifier 820 also includes a gain block 800 connected to the main output 791 of the optical amplifier 20 (first stage optical amplifier 830) wherein the gain block 800 forms a second stage optical amplifier 840 of the two-stage optical amplifier 820. Usually, for a multi-stage optical amplifier, the first stage determines the noise figure of the whole amplifier, and the second stage determines the gain and saturated output power of the whole amplifier. The total noise figure may be expressed as total NF=NF1+NF2/G1, where NF1 and NF2 are the noise figures of the first and seconds stages alone, and G1 is the gain of the first stage.

An input optical signal input into the first stage optical amplifier 830 is amplified through the first stage optical amplifier 830 and its SNR is increased through the optical amplifier 20 resulting in a main output optical signal at the main output 791. The main output optical signal then propagates to the second stage optical amplifier 840. The second stage optical amplifier 840 then amplifies the main output optical signal without significantly increasing the noise figure of the two-stage optical amplifier 820.

In some embodiment of the invention, the first-stage optical amplifier 830 may comprise the optical amplifier 420. In other embodiments of the invention, the second-stage optical amplifier may comprise a plurality of gain blocks similar to gain block 800 and connected in series to form a multistage optical amplifier.

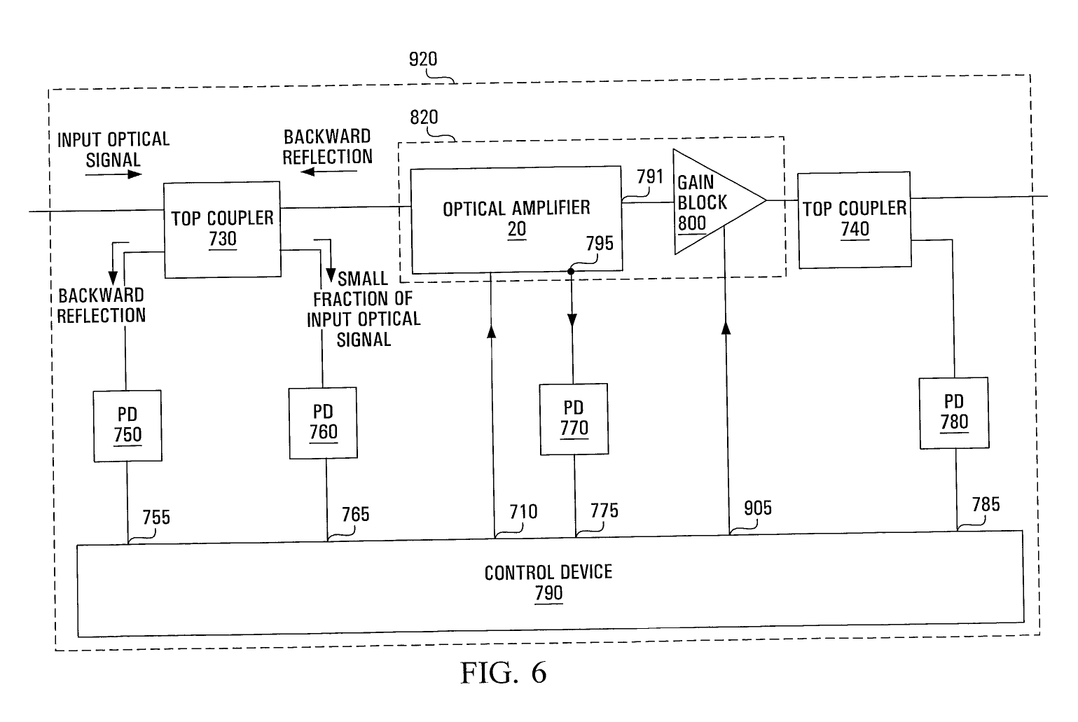

Referring to FIG. 6, shown is a schematic block diagram illustrating a two-stage optical amplifier 920 that includes the two-stage optical amplifier 820 and a control mechanism for tuning the performance of the optical amplifier 820. The two-stage optical amplifier 920 is similar to the two-stage optical amplifier 720 described with reference to FIG. 4 except that the optical amplifier 20 of the optical amplifier 720, which is a single-stage optical amplifier, has been replaced by the two-stage optical amplifier 820. In addition, there is an output 905 of the control device 790 connected to the gain block 800 for controlling the gain in the gain block 800. Once again, typically the output of power detector 770 is used by the control device 790 to tune the optical path length difference and the gain in the optical amplifier 20 for the best performance.

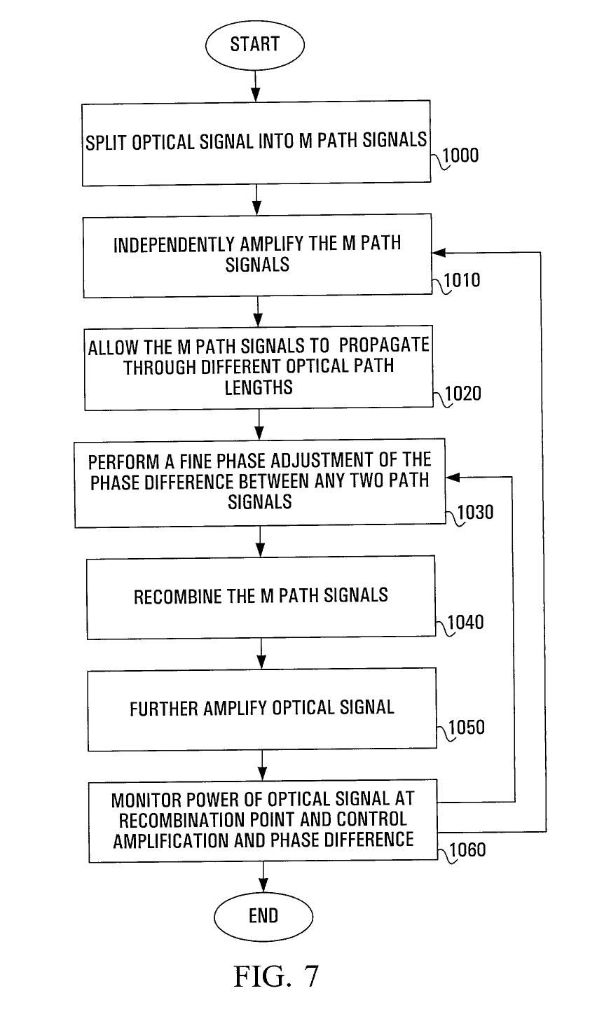

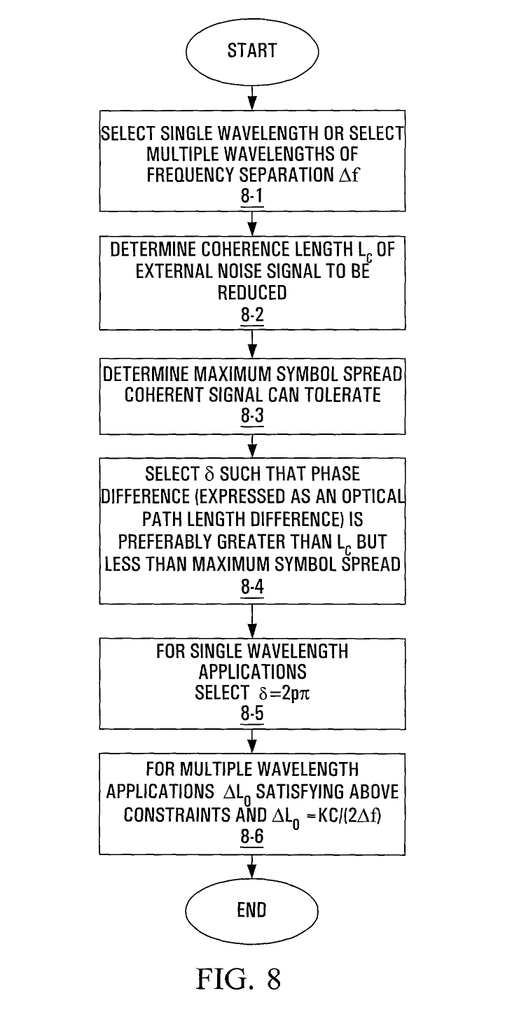

Referring to FIG. 7, shown is a flow chart of a method of amplifying an optical signal. At step 1000 the optical signal is split into M path signals wherein M substantially satisfies M≧2. The M path signals are then independently amplified (step 1010) such that ASE generated, during amplification, in each path carrying a respective one of the M path signals is un-correlated from one path to another. At step 1020 the M path signals are propagated through different optical path lengths so that external noise path components of noise path components of the path signals are at least partially incoherent and preferably completely incoherent. At step 1030, a fine phase adjustment is performed on at least one of the M path signals but preferably on all of the path signals such that an overall phase difference, δ, between any two of the M path signals may be adjusted in a manner that allows signal components of the M path signals to be recombined, at step 1040, at a main output while ASE power and preferably also external noise power associated with the noise path components of the M path is substantially divided between the main output and M−1 subsidiary outputs. The manner by which the overall phase difference, δ, is chosen is described herein below with respect to FIG. 8. At step 1050 the optical signal which is output from the main output is optionally further amplified. Step 1060 is also optional and provides a control mechanism for controlling output. At step 1060, output power is monitored and instructions for adjusting the overall phase difference, δ, (step 1030) and adjusting the gain (step 1010) are provided so that, at a main output, the power of the signal path components is maximized and the power of the noise path components is minimized.

Referring to FIG. 8, shown is a flow chart of a method of designing an overall phase difference for use in the optical amplifiers of FIGS. 2 to 6. The method starts with the identification of a single wavelength of interest X, or the identification of a set of wavelengths of interest having constant frequency spacing Δf between any two consecutive wavelengths (step 8-1). In the following steps the coherence length, L_{c}, of the external noise path components of the noise path components of the M path signals is determined (step 8-2). A maximum symbol shift, ΔLₘₐₓ=χC/R, the signal path components can tolerate (step 8-3) is also determined. An optical path length difference between any two signal path components is selected by choosing an phase difference such that an optical path length difference, ΔLₒ, satisfies the following criteria: 1) ΔLₒ<ΔLₘₐₓ for satisfactory symbol shift (step 8-4); 2) In the event that L_{c}>ΔLₘₐₓ preferably choose ΔLₒ as large as possible while satisfying ΔLₒ<ΔLₘₐₓ; otherwise choose ΔLₒ>L_{c} (step 8-4); 3) For single wavelength applications, a phase difference is selected associated with any two paths of the M path signals, resulting in a phase difference, δ=2pπ where p=0, ±1, ±2, . . . , between the signal path components of any two of the M path signals at a combination point (step 8-5); 4) For multiple wavelength applications, ΔLₒ=KC/(2Δf) (step 8-6) where Δf=f′−f and, f′ and f are the frequencies of two consecutive channels of the input optical signal. To satisfy these three constraints simultaneously invoke the proper selection of K.

Numerous modifications and variations of the present invention are possible in light of the above teachings. For example, a multistage optical amplifier may comprise N of the above-described optical amplifiers connected serially. Any one of the above-described optical amplifiers may also be used as pre-amplifiers. Such a pre-amplifier may precede any optical receiver. It is therefore to be understood that within the scope of the appended claims, the invention may be practised otherwise than as specifically described herein.

We claim:

1. A method of amplifying an optical signal comprising:
splitting the optical signal into two path signals each having an external noise path component and a signal path component;
amplifying the path signals through independent amplification stages such that, after amplification, each path signal carries a respective ASE (amplified spontaneous emission) path component wherein the ASE path components are substantially un-correlated;
performing a respective phase adjustment to at least one of the path signals before or after amplification such that the signal path components of the path signals can be combined constructively at a combination point;
at the combination point, combining the path signals to produce an output optical signal.

2. A method according to claim 1 wherein the ASE path components being substantially un-correlated results in ASE power of the respective ASE path components being substantially divided between a main output and a subsidiary output.

3. A method according to claim 1 wherein the respective phase adjustment(s) is/are further performed in a manner such that, at the combination point, the external noise path components are at least partially incoherent resulting in external noise power being diverted to a subsidiary output.

4. A method according to claim 1 wherein a phase adjustment is applied to both path signals.

5. A method according to claim 1 wherein the respective phase adjustment(s) is/are applied by passing the path signals through respective OTM (optical transmission media) having different optical path lengths.

6. A method according to claim 1 wherein the respective phase adjustment(s) is(are) applied by controlling non-linear effects in an active gain region through which the path signals propagate.

7. A method according to claim 5 wherein an optical path length difference, ΔLₒ, between the OTM is chosen to satisfy a symbol shift tolerance.

8. A method according to claim 1 wherein the respective phase adjustment(s) is/are achieved by employing an optical path length difference, ΔLₒ, between the two path signals, the optical path length difference substantially satisfying ΔLₒ≦χC/ω wherein C is the speed of light, ω is a carrier data rate of the input optical signal and χ is a symbol shift tolerance.

9. A method according to claim 7 wherein the external noise path components have a coherence length, L_{c}, and the phase adjustments are achieved by employing an optical path length difference, ΔLₒ, between the two path signals, wherein if the coherence length, L_{c}, is less than a maximum optical path length difference, ΔLₘₐₓ, the path signals can tolerate while satisfying the symbol shift tolerance then the optical path length difference substantially satisfies L_{c}<ΔLₒ≦ΔLₘₐₓ, otherwise the optical path length difference substantially satisfies ΔLₒ≦ΔLₘₐₓ.

10. A method according to claim 1 wherein the respective phase adjustment(s) result(s) in the signal path components of the path signals being substantially in phase with each other to an integral multiple of 2π.

11. A method according to claim 1 applied to an optical signal comprising a plurality of equally spaced channels wherein any two consecutive channels with frequencies f′ and f of the equally spaced channels differ by Δf=f′−f and wherein an optical path length difference, ΔLₒ, between the two path signals, substantially satisfies ΔLₒ=KC/(2Δf), wherein K=1,2,3, . . . and C is the speed of light in vacuum.

12. An optical amplifier arrangement comprising:
an optical splitter, two OTM, a gain block within each one of the OTM and an optical coupler, wherein the optical splitter is adapted to split an optical signal into two path signals, each having a signal path component and a noise path component, that propagate through a respective one of the OTM, are amplified by a respective one of the gain blocks and recombined through the optical coupler; and
a phase controller in at least one of the optical transmission media wherein the phase controller is adapted to apply a phase adjustment to a respective one of the two path signals such that, at the optical coupler, substantially all of the power of the signal path components is produced at a main output and wherein a portion of the power of the noise path signals is diverted to a subsidiary output.

13. An optical amplifier according to claim 12 wherein an ASE power arising from amplification in the gain blocks is substantially divided between the main output and one or more subsidiary outputs irrespective of the phase adjustment.

14. An optical amplifier according to claim 12 wherein the phase controller is further adapted to apply the phase adjustment in a manner that, at the optical coupler, external noise path components of the noise path components are at least partially incoherent resulting in at least a portion of external noise power being diverted to the subsidiary output.

15. An optical amplifier according to claim 12 wherein at least one of the gain blocks is an EDFA (erbium-doped fiber amplifier).

16. A multistage optical amplifier comprising the amplifier arrangement of claim 12 in combination with one or more optical amplifier(s).

17. A multistage optical amplifier according to claim 16 wherein the optical amplifier arrangement is a first stage of the multistage optical amplifier.

18. A pre-amplifier comprising the optical amplifier arrangement of claim 12.

19. A receiver structure comprising the pre-amplifier of claim 18 preceding an optical receiver.

20. An optical amplifier arrangement according to claim 12 comprising an additional phase controller.

21. An optical amplifier arrangement according to claim 12 wherein the optical splitter, the two OTM, and the output optical coupler together comprise a Mach-Zehnder interferometer.

22. An optical amplifier arrangement according to claim 12 applied to an optical signal comprising a plurality of equally spaced channels wherein any two consecutive channels with frequencies f′ and f of the equally spaced channels differ by Δf=f′−f, and wherein an optical path length difference, ΔLₒ, between the two path signals, substantially satisfies ΔLₒ=KC/(2Δf), wherein K=1,2,3, . . . and C is the speed of light in vacuum.

23. An optical amplifier arrangement according to claim 12 further comprising processing and sensing circuitry adapted to control the phase adjustment.

24. An optical amplifier arrangement according to claim 12 further comprising processing and sensing circuitry adapted to control gain in the gain blocks.

25. An optical amplifier arrangement according to claim 12 wherein the optical splitter is a 1×2 3-dB single-mode fused-fiber coupler.

26. An optical amplifier arrangement according to claim 12 wherein the optical splitter is a 2×2 3-dB single-mode fused-fiber coupler, wherein one of two inputs of the 2×2 3-dB single-mode fused-fiber coupler is terminated locally.

27. An optical amplifier arrangement according to claim 12 wherein the optical coupler is a 2×2 3-dB single-mode fused-fiber coupler.

28. An optical amplifier arrangement according to claim 12 wherein the OTM are wave-guides.

29. An optical amplifier arrangement according to claim 12 wherein the OTM are optical fibers.

30. An optical amplifier arrangement according to claim 12 comprising at least one additional optical transmission medium connected to the optical splitter and to the optical coupler for a total of M OTM.

31. An optical amplifier arrangement according to claim 30 wherein each one of the at least one additional optical transmission medium comprises a gain block.

32. An optical amplifier arrangement according to claim 30 wherein each one of the at least one additional optical transmission medium comprises a phase controller.
